(19) United States
(12) Patent Application Publication
(10) Pub. No.: US 2017/0091774 A1
(43) Pub. Date: Mar. 30, 2017

(54) Biometric Fingerprint Payment System for Mobile Devices

(71) Applicant: Desiree White, Los Angeles, CA (US)

(72) Inventor: Desiree White, Los Angeles, CA (US)

(21) Appl. No.: 15/280,158

(22) Filed: Sep. 29, 2016

Related U.S. Application Data
(60) Provisional application No. 62/234,261, filed on Sep. 29, 2015.

(51) Int. Cl. G06Q 20/40; G06K 9/00; G06Q 20/10

(52) U.S. Cl. CPC G06Q 20/40145; G06Q 20/102; G06K 9/00013

(57) ABSTRACT

A biometric transaction system having a merchant station with a biometric reader, a server programmed to receive the biometric information from the merchant station to verify the authenticity of user using the merchant station by determining whether the user has previously registered biometric information and payment information for transactions. If the user is previously registered, confirms a transaction, and the merchant authenticates the user attempting the transaction, the system processes the payment for the transaction using the previously stored payment information.

### CROSS-REFERENCE TO RELATED APPLICATIONS

This application claims priority to U.S. Provisional Application No. 62/234,261 filed on Sep. 29, 2015.

### BACKGROUND OF THE INVENTION

1. Field of the Invention

The present invention relates to point-of-sale transaction systems and, more particularly, to a biometric recognition system for use with mobile devices.

2. Description of the Related Art

Every three minutes someone falls victim to identity theft and fraud is quite pervasive in the payment processing industry. Even some of the most trusted sources are at risk from scammers swiping customer credit card information. Platforms such as PayPal have made online purchasing without the need of a physical card, but have fallen short on providing a secure way to pay for brick and mortar shopping. As consumers are smarter, savvier and are looking for a secure way to make purchases that will not compromise their personal information and credit card numbers there is a need for a system that can adequately protect consumers during retail, point of sale transaction.

### BRIEF SUMMARY OF THE INVENTION

The present invention is a biometric transaction system having a merchant station having a biometric reader for reading biometric information from a user that is programmed to transmit the biometric information along with a request for payment of a transaction. A remote server is programmed to receive the biometric information, to determine whether the biometric information matches previously stored biometric information for the user, and to process payment for the transaction if the biometric information matches the previously stored biometric information for the user. The server is also programmed to establish a user account containing user specific biometric information and user specific payment information. The system may also include a mobile device associated with a biometric scanner programmed to collect biometric information from a user and transmit the biometric information to the server. The mobile device is further programmed to accept payment information from the user and transmit the payment information to the server. The server is programmed to send a confirmation request to the user after determining that the biometric information matches previously stored biometric information for the user. The server is also programmed to send an authentication request to the merchant after determining that the biometric information matches previously stored biometric information for the user. The server only processes payment for the transaction if the user responds affirmatively to the confirmation request and the merchant responds affirmatively to the authentication request. The mobile device can have a dedicated mobile application in communication with the server and the confirmation request is sent to the user using the dedicated mobile application and the merchant station can have a dedicated merchant application in communication with the server and the authorization request is sent to the merchant using the dedicated merchant application.

To complete a transaction, a merchant allows a user attempting a transaction to supply biometric information. The transaction details and user biometric information are sent to a remote server that uses the biometric information to retrieve previously stored user biometric information and payment information. Once the user and merchant have verified that the transaction is acceptable, the system processes the payment for the transaction using the previously stored user payment information

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a biometric payment system according to the present invention;

FIG. 2 is a flowchart of a configuration and transaction process for a biometric payment system according to the present invention; and

FIG. 3 is a schematic of the high level biometric activities for biometric payment system according to the present invention.

### DETAILED DESCRIPTION OF THE INVENTION

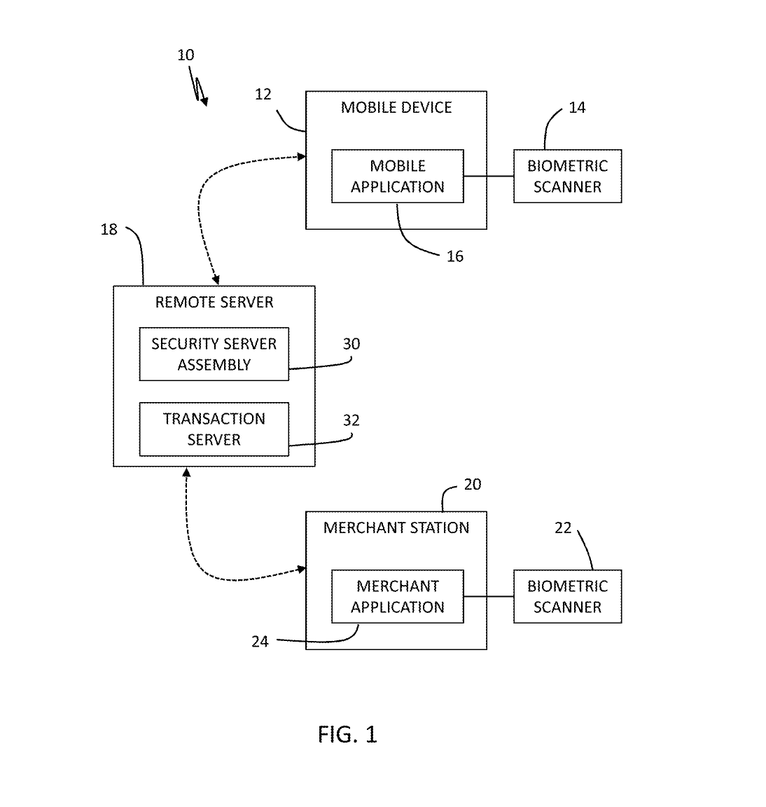

Referring now to the drawings, wherein like reference numerals refer to like parts throughout, there is seen in FIG. 1 a biometric fingerprint payment system 10 comprising a mobile device 12 associated with a biometric scanner 14, which may be external to or integrated into mobile device 12. An external biometric scanner 14 may be interfaced with mobile device 12 via an existing USB port, wireless protocols (such as Bluetooth®), etc., charging port, lightening port, near field communication (NFC) and/or the audio headphone or HF audio jack. For example, biometric scanner 14 may comprise a capacitive fingerprint sensor that uses low electrical current to generate an image of the fingerprint ridges in contact with the sensor surface that make up a fingerprint. Biometric scanner 14 may also comprise a high definition camera that can capture an image of a retina or to perform facial recognition. As described more fully herein, biometric scanner 14 may only need to be associated with mobile device 14 during an initial configuration step. As an example, biometric scanner 14 may comprise an AES 128 bit processor compliant with the Federal Bureau of Investigation's IAFIS (Integrated Automated Fingerprint Identification Systems) image quality specifications that is designed for use with Personal Identify Verification (PIV) systems, such as those mandated for use with Federal Employees and Contractors by Homeland Security Presidential Directive 12 (HSPD-12).

A dedicated mobile application 16 resident on mobile device 12 is programmed to communicate with and operate biometric scanner 14 to acquire biometric information. Application 16 is programmed to associate the biometric information establishing the identity of the individual along with transaction payment information, such as debit or credit card information, and transmit both the biometric and payment information to a remote server 18 to establish a user account. Application 16 is further programmed to, once a user account is established, communicate with remote server 18 to authorize the use of transaction payment information to pay for a commercial transaction. Preferably, application 16 is programmed to require the entry of a passcode prior to use and in response to a request from remote server 18 for authorization to use transaction payment information to pay for a commercial transaction. Application 16 may additionally be programmed to cause mobile device 12 to present identifying information, such as an image of an authorized user, on the display of mobile device 12 for viewing by a merchant who has initiated a transaction request through system 10. Mobile device 12 functionality may be provided as a kiosk where the appropriate actions can be taken, including establishing account and managing stored payment methods and electronic funds.

System 10 further comprises a merchant station 20 associated with a merchant biometric scanner 22, which may be external to or integrated into merchant station 20. For example, merchant station 20 may comprise a point-of-sale (POS) system residing at a retail location as it known in the art. An external or integral merchant biometric scanner 22 may be interfaced with merchant station 20 via an existing USB port, wireless protocols (such as Bluetooth®), etc. and may comprise a capacitive fingerprint sensor that uses low electrical current to generate an image of the fingerprint ridges in contact with the sensor surface that make up a fingerprint. Merchant station 20 may be a smartphone, tablet or transaction terminal executing a merchant application 24 that is programmed to acquire biometric information from retail consumer that is provided access to biometric scanner 22 of merchant station 20. Merchant application 24 is further programmed to communicate acquired biometric information to remote server 18 to initiate a payment transaction and to complete a payment transaction if remote server 18 authorizes the use of preconfigure payment information for a particular transaction. Merchant application 24 may additionally be programmed to cause merchant station 20 to present identifying information, such as an image of an authorized user, on the display of merchant station 20 for viewing by the merchant who has initiated a transaction request through system 10 to authenticate the user making the purchase. As with mobile device 12, merchant station 20 where the appropriate actions may be are taken, such as effecting a retail payment.

Remote server 18 is programmed to create individual user accounts containing user-specific biometric information provided in advance by users using mobile device 12 and associated biometric scanner 14, and to associate the biometric information with one or more methods of payment also provided by a user via mobile application 16 of mobile device 12. Remote server 18 is further programmed to receive a transaction request from a merchant station 20 via merchant application 24, along with any biometric information acquired by merchant station 20 using merchant biometric scanner 22. Remote server 18 is additionally programmed to match the biometric information sent by merchant application 24 against preconfigured user biometric information. If the user supplying the biometric information to merchant application 24 has a pre-established account, server 18 is programmed to communicate a transaction confirmation request to the particular mobile device 12 of the user that supplied biometric information to merchant application 24. If user of mobile device 12 authorizes the transaction, and selects a particular payment method from those associated with the account of the user or accepts the use of a single or default payment method, such as by supplying the appropriate password and/or inputting user approval or confirmation into dedicated mobile application 16, server 18 is programmed to receive those confirmation and payment instructions from mobile device 12. Prior to or upon receiving confirmation and payment instructions from mobile device 12, server 18 is programmed to trigger merchant application 24 to display identifying information to the merchant for confirmation of the identity of the user. For example, merchant may be provided with a picture of user or any other indicia that can be matched against the user initiating the transaction. Once merchant has confirmed the identity of user using merchant application 24, server 18 is programmed to execute a payment to merchant using the payment method selected by user. Server 18 may then be programmed to provide user with a receipt for the transaction, such as by emailing user or sending a receive to dedicated mobile application 16

Communications between the various hardware component and application of the present invention preferably include security layers to protect data integrity and protect against third party breaches. For example, data transfers between mobile device 12 and biometric scanner 14, mobile device 12 and server 18, and merchant station 20 and server 18 can be encrypted using conventional encryption technologies, such as by using a Secure Socket Layer (SSL) process.

In an embodiment of the invention, server 18 distributed into a security server assembly 30 and a transaction server 32. For example, security server assembly 30 may comprise multiple independent servers that initiate a session with merchant station 20 for a given transaction. Once security server assembly 30 has received user information and confirmed the existence of an appropriate user account with a payment, each independent server in assembly 30 provides a security token to transaction server 32 via an internal local area network (LAN) connection. Transaction server 32 may then complete the payment transaction using conventional credit and debit card transaction processes, log the transaction, and send the appropriate receipts to the user and the merchant. As an alternative, transaction server 32 may comprise an electronic bank or retail account that is pre-loaded with funds by a user, a prepaid electronic service such as PayPal®, or the like. Transaction server 32 may host a website or mobile application connection that allows a user, via a webpage or mobile application 16, that allows a user to manage his or her account, to add or remove funds, to change third party billing information, etc.

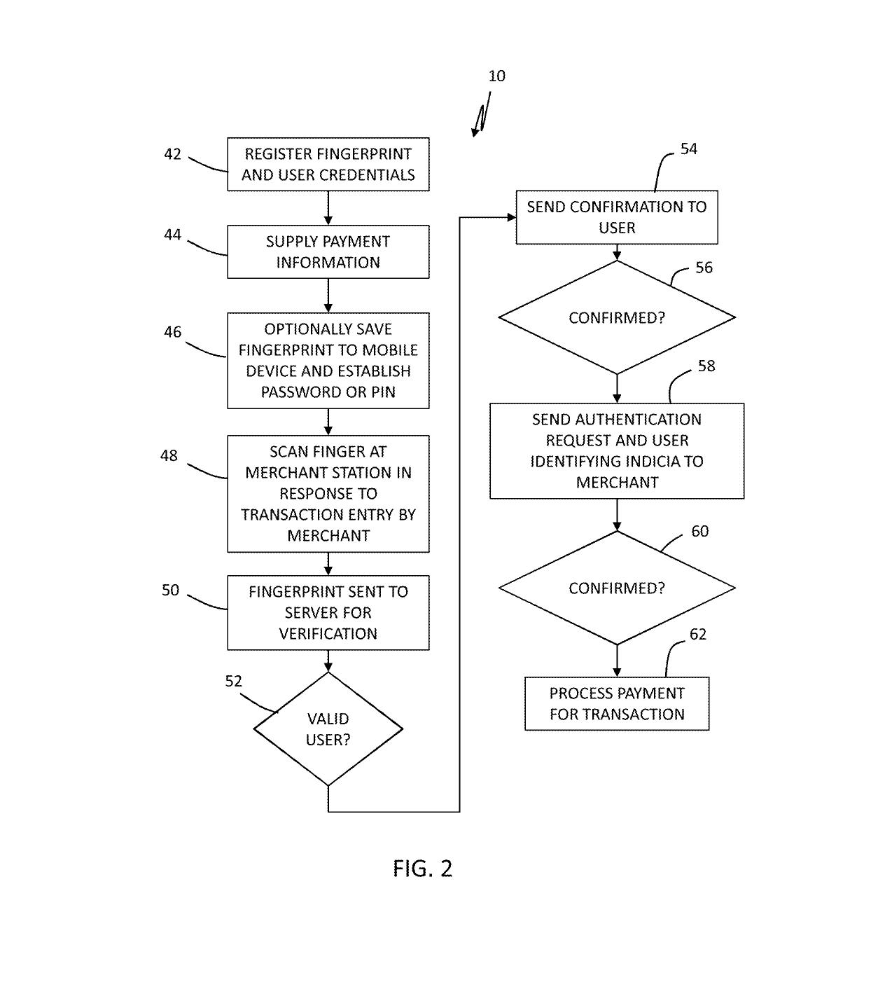

Referring to FIG. 2, an exemplary method 40 of using system 10 begins with a user registering with system 10 by recording his or her fingerprint and entering user credentials 42. Next, the user supplies payment information 44, such as credit or bank debit cards, that can be used by system 10 to effect a payment when a user engages in a future sales transaction. The user may then save fingerprint data locally to a mobile device and set a pin or password 46 for confirming a proposed future transaction. During a subsequent retail transaction, a merchant enters the amount of the transaction into station 20 and allows user to scan his or her finger using merchant hardware 48. The scanned fingerprint data is sent to server 18 for verification 50, such as by transmitting the data over a private SSL tunnel over land or wireless networks to server 18. If a valid user account exists, server 18 sends a confirmation request to the user 54 and, if confirmed 56, server 18 an authentication request along with user identifying indicia 50 to the merchant. If authorization is confirmed 60, server 18 effects payment using the previously stored payment information and processing the payment 62 in the conventional manner for accomplishing credit and debit transactions. As noted above, merchant station 20 and/or mobile device 12 functionality may be provided as a kiosk where the appropriate steps are taken, including establishing account, effecting a retail payment, or managing stored payment methods and electronic funds.

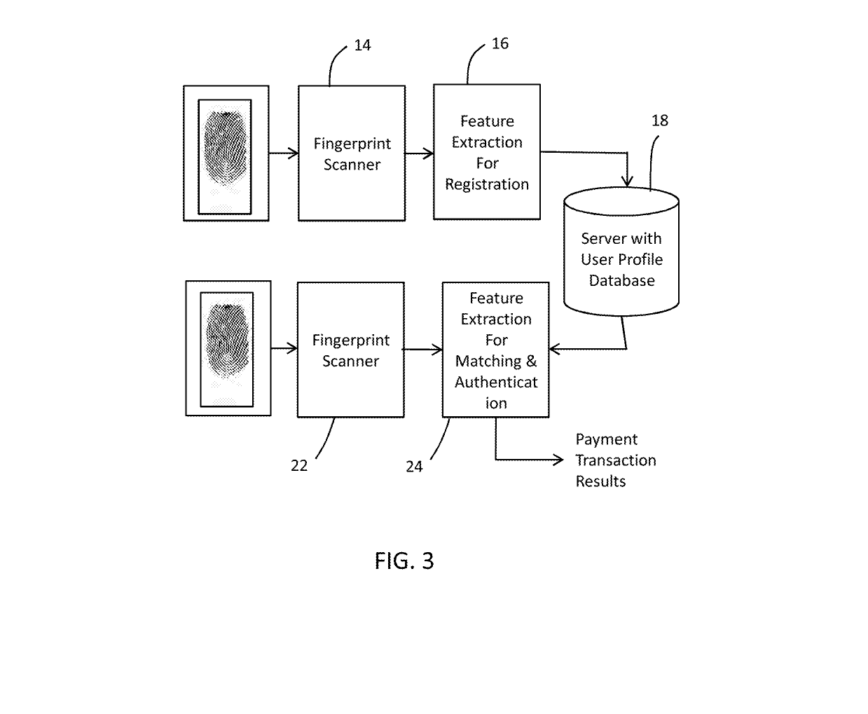

Referring to FIG. 3, system 10 thus record user fingerprints and combines biometric identification with a security pin or password entry to improve security during a merchant transaction. System 10 further provides a convenient way for a user to link your charge accounts and debit/credit cards to a single system for use in paying for a transaction. Fingerprints are preferably stored as an encrypted data file on the mobile device that can only be decrypted with a pin number or password before it is used and sent out for one instance. Every transaction initiates a session with multiple security servers that perform the verification of the user and obtains the necessary information in parts that are sent to one or more transaction servers along with security token to prevent against illicit attacks. The transaction server completes transaction, preferably with a predetermined session timeout. Upon successfully receiving the information and having checked the integrity of the data, the transaction server can process the payment using conventional payment gateways.

The present invention may be a system, a method, and/or a computer program product. Storage mediums may be, for example, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods, and computer program products of the present invention. Each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A biometric transaction system, comprising:
a merchant station having a biometric reader for reading biometric information from a user that is programmed to transmit the biometric information along with a request for payment of a transaction; and
a server programmed to receive the biometric information, to determine whether the biometric information matches previously stored biometric information for the user, and to process payment for the transaction if the biometric information matches the previously stored biometric information for the user.

2. The system of claim 1, wherein the server is programmed to establish a user account containing user specific biometric information and user specific payment information.

3. The system of claim 2 further comprising a mobile device associated with a biometric scanner programmed to collect biometric information from a user and transmit the biometric information to the server.

4. The system of claim 3, wherein the mobile device is further programmed to accept payment information from the user and transmit the payment information to the server.

5. The system of claim 4, wherein the server is programmed to send a confirmation request to the user after determining that the biometric information matches previously stored biometric information for the user.

6. The system of claim 5, wherein the server is programmed to send an authentication request to the merchant after determining that the biometric information matches previously stored biometric information for the user.

7. The system of claim 6, wherein the server only process payment for the transaction if the user responds affirmatively to the confirmation request and the merchant responds affirmatively to the authentication request.

8. The system of claim 7, wherein the mobile device comprises a dedicated mobile application in communication with the server and the confirmation request is sent to the user using the dedicated mobile application.

9. The system of claim 8, wherein the merchant station comprises a dedicated merchant application in communication with the server and the authorization request is sent to the merchant using the dedicated merchant application.

10. The system of claim 1, wherein the biometric scanner comprises a capacitive fingerprint sensor that is programmed to generate an image of the fingerprint ridges of a fingerprint of the user.

11. A method of establishing a biometrically authenticated transaction, comprising the steps of:
providing a merchant station having a biometric reader for reading biometric information from a user that is programmed to transmit the biometric information along with a request for payment of a transaction; and
providing a server programmed to receive the biometric information, to determine whether the biometric information matches previously stored biometric information for the user, and to process payment for the transaction if the biometric information matches the previously stored biometric information for the user.

12. The method of claim 11, wherein the server is programmed to establish a user account containing user specific biometric information and user specific payment information.

13. The method of claim 12 further comprising a mobile device associated with a biometric scanner programmed to collect biometric information from a user and transmit the biometric information to the server.

14. The method of claim 13, wherein the mobile device is further programmed to accept payment information from the user and transmit the payment information to the server.

15. The method of claim 14, wherein the server is programmed to send a confirmation request to the user after determining that the biometric information matches previously stored biometric information for the user.

16. The method of claim 15, wherein the server is programmed to send an authentication request to the merchant after determining that the biometric information matches previously stored biometric information for the user.

17. The method of claim 16, wherein the server only process payment for the transaction if the user responds affirmatively to the confirmation request and the merchant responds affirmatively to the authentication request.

18. The method of claim 17, wherein the mobile device comprises a dedicated mobile application in communication with the server and the confirmation request is sent to the user using the dedicated mobile application.

19. The method of claim 18, wherein the merchant station comprises a dedicated merchant application in communication with the server and the authorization request is sent to the merchant using the dedicated merchant application.
